(19) United States
(12) Patent Application Publication
(10) Pub. No.: US 2009/0145692 A1
(43) Pub. Date: Jun. 11, 2009

(54) Novel rear deck service ladder for combines

(76) Inventors: Wayne Flickinger, Oxford, PA (US); Andrew Lauwers, Stevens, PA (US); Marion D. Mencer, III, Lancaster, PA (US)

Correspondence Address: CNH AMERICA LLC, INTELLECTUAL PROPERTY LAW DEPARTMENT, PO BOX 1895, M.S. 641, NEW HOLLAND, PA, 17557, US

(21) Appl. No.: 12/001,097

(22) Filed: Dec. 10, 2007

(51) Int. Cl. A01D 41/12

(52) U.S. Cl. 182/127

(57) ABSTRACT

A rear deck service ladder for combine harvesters having rear M.O.G. discharge ports, said ladders being retractable and extendible without interfering with the discharge port.

### TECHNICAL FIELD

The present invention relates to devices and methods for accessing the engine servicing platforms of combine harvesters, and it particularly relates to platform ladders and methods for using such ladders at the rear of a combine.

### BACKGROUND ART

A variety of different ladders are presently known to provide access between the ground and the engine service platform of a combine. Folding ladders incorporating spring biased over-centering linkages to hold the ladders in stowed or closed positions without the need of a separate latching mechanism, have been known since 1978 from U.S. Pat. No. 4,131,293 by Kindle. However, typical ladders for combines remain relatively short, on the order of three to five steps, and typically the ladders simply swing or pivot from deployed position into a position for storage. Additionally, several folding step arrangements are in the prior art. Also ladders that fold into or against a vehicle body are known, and there are known embodiments utilizing tracks to align a ladder into a storage hold.

However, there are certain recent model combines which have functional drawbacks inhibiting the deployment of ladders at the extreme rear end of the combine. Principally, among these drawbacks, is the difficulty of accommodating the discharge of straw and other M.O.G. (material other than grain) at the rear of the combine. That is, the ladder must be stored while also allowing ample room for the discharging straw and M.O.G. to flow freely, without being obstructed by the ladder. For purposes of homologation, the ladder, when deployed, must be long enough to extend beyond the discharge opening. Also prior art ladders do not accommodate variations in vehicle height resulting from variation in the tire package. Furthermore, the ladders, when in the storage position at the rear, will accumulate straw and M.O.G. discharge, which subsequently spills onto the operator when he manually deploys the ladder into the service position.

An access device or ladder, and a method for storing and deploying same while overcoming the above-described drawbacks, would provide an unexpected advancement in combine harvester design, while satisfying a longfelt need for accessing combine harvester engine service platforms, when there is a discharge port located at the rear of the combine, which location heretofore necessitated having the access ladders on the right-hand side of the combine service platform, rather than at the rear.

### SUMMARY OF THE INVENTION

The above-described drawbacks and others which will be apparent to those skilled in the art are overcome by the access ladder and method of the present invention which embodies a ladder having a smaller portion that flips up at the bottom of the ladder, which bottom portion of the ladder connects to adjustable trim panel on the combine allowing cooperation with variations in vehicle height and width. The trim panels enable the ladder's deployment from machines of varying height or width without the need to modify the individual ladder or platform assembly. The ladder also has an upper portion which, in the storage position, allows the ladder to be in the same plane as the hand railing on the engine servicing platform, but which upper portion slides both vertically and rearwardly, along tracks, when deployed, without the necessity of spring-biased linkages for holding the ladder in a stowed or closed position. The upper portion is connected to contoured lower support arms that wrap around the straw and M.O.G. discharge door, which support arms neck into a narrow position, but allowing the deployed ladder to clear the discharge door for the straw and M.O.G. discharge port.

### BRIEF DESCRIPTION OF THE DRAWINGS

FIG. 1 is a left side elevation of the rear of a combine incorporating the present invention;

FIG. 2 is a perspective view of a prior art combine having its access ladder on the right-hand side of the combine;

FIG. 3 is a perspective view of a combine showing the rear access ladder of the present invention in its stored position;

FIG. 4 is a left side view of an engine service platform embodying the rear access ladder of the present invention in its stored position;

FIG. 5 is a left side view of an engine service platform embodying the rear access ladder of the present invention, said ladder being deployed halfway but prior to unfolding its bottom portion;

FIG. 6 shows a left side view of an engine service platform embodying the rear access ladder of the present invention being fully deployed downward but without unfolding its lower portion;

FIG. 7 is a perspective view of an engine service platform embodying the rear access ladder of the present invention being fully deployed and having its lower portion unfolded; and

FIG. 8 illustrates a rear elevational view of a combine including its engine service platform embodying the rear access ladder of the present invention in its fully stored position.

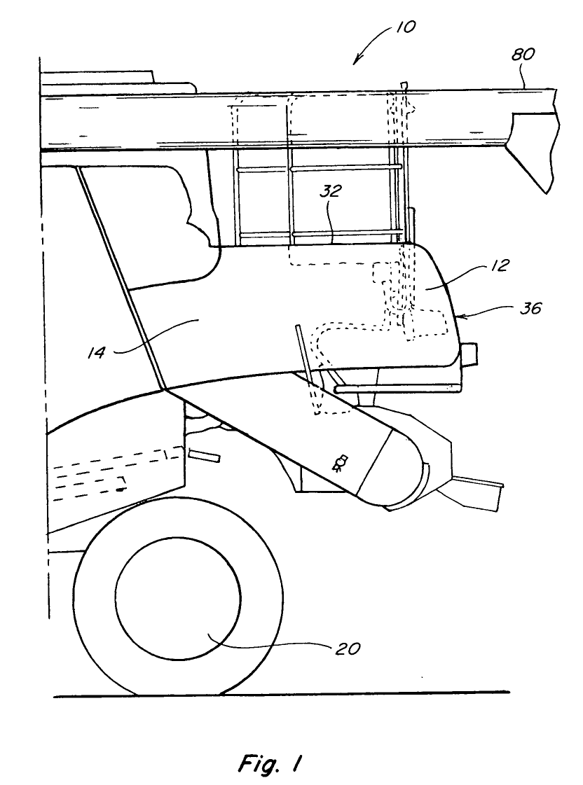

### DETAILED DESCRIPTION OF THE INVENTION

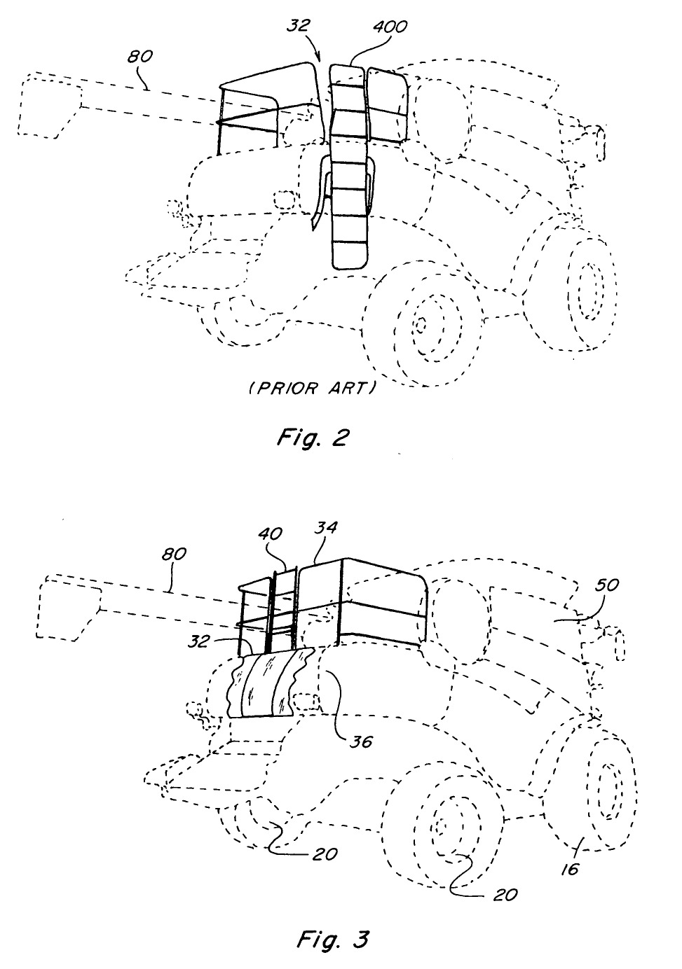

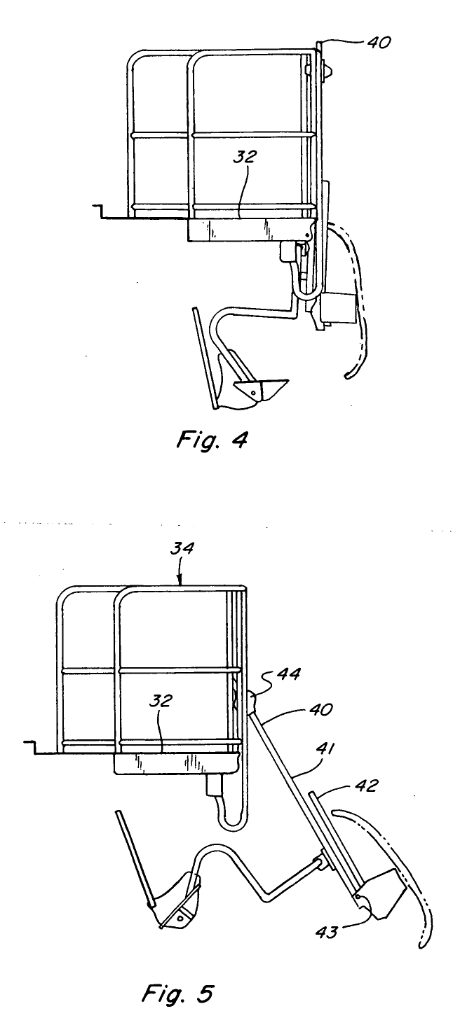

Referring generally to the accompanying drawings, the invention disclosed herein can be illustrated on an agricultural vehicle such as the combine shown generally as 10. The combine will typically include a chassis or body 12 having vertical side walls 14. The body 12 is supported on a pair of large driven wheels 16 at the front of the combine 10 and a pair of wheels 20 at the rear thereof. An operator's platform 32 and cab 50, a crop gathering header (not shown), a feeder 26 and a grain delivery chute 80 are conventional. An engine service and access platform or catwalk 32 having guardrails 34 is provided at the rear end 36 of the combine. Referring to FIG. 2, the rear access ladder 40 of the present invention is integrally stored in upright fashion on the rear access platform 32 so as to define a movable extension of the handrails 34. This configuration is in contrast to the prior art access ladder 400 configuration as shown in FIG. 2 which is located on the right-hand side (as opposed to being located at the rear) of the engine service platform 32 and when stored merely swings into the up position and swings into the down position when deployed.

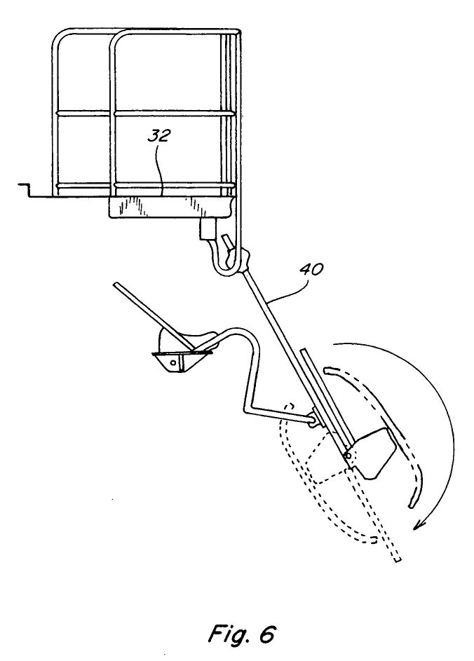

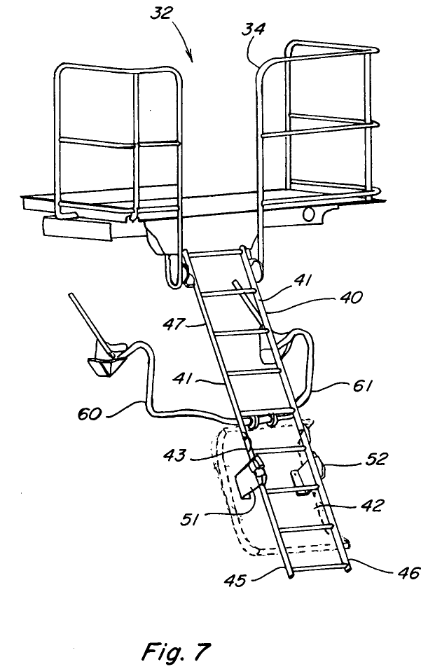

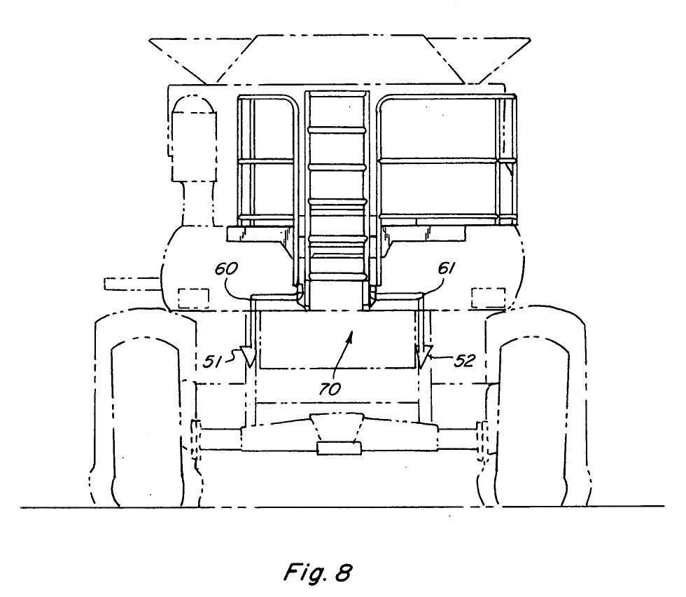

Referring to FIGS. 4, 5 and 6, the drawings progress from FIG. 4 where the rear access ladder 40 of the platform 32 is fully stowed away, to FIG. 5 where the ladder 40 is partially deployed into service, to FIG. 6 where the ladder 40 is more advanced into service, and onto FIG. 7 where ladder 40 is fully deployed and unfolded. Ladder 40 comprises two hinged portions 41 and 42. Ladder portion 41 defines a longer upper portion of ladder 40, which portion 41 is slidingly engaged at its top end 44 to up and down along two rails of handrails 34. Trim panel attachments 51 and 52 attach to the uprights 45 and 46 respectively of the ladder lower portion 42. These trim panel connections allow the majority of the trim panels of varying width machines to remain the same while the panel's width changes to accommodate varying widths. Lower support arms 60 and 61 are contoured to wrap around straw door opening 70 as shown in FIG. 8.

It will be understood that changes in the details, materials, steps, and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the invention. Accordingly, the following claims are intended to protect the invention broadly as well as in the specific form shown.

1-3. (canceled)

4. A retractable ladder assembly for accessing the rear service deck of a combine, wherein the deck has handrailing and the combine has an residue discharge port located at the rear of the combine, the ladder assembly is movable between a folded and stored position and a unfolded and deployed position, the ladder assembly comprising:
an upper portion having a top end and a bottom end, the upper portion slidably engageable at a top end to the handrailing for sliding the upper portion up and down with respect to the handrailing, further wherein the upper portion rotates about the top end such that the upper portion is retracted from the stored position in a simultaneous downward and rearward movement toward the deployed position;
a lower portion hingedly coupled to the bottom end of the upper portion such that the lower portion can be flipped from one side of the bottom portion to the other side of the bottom portion, wherein the lower portion has trim panel connectors for coupling with trim panel attachments on the combine; and
support arms extending from the upper portion, the support arms are shaped to wrap around the contour of the rear of the combine, the support arms maintain the ladder assembly in the deployed position and prevents the ladder assembly from obstructing the residue discharge port.

5. The ladder assembly of claim 4, wherein the support arms each have a first portion extending outwardly from the upper portion and a second portion which bends substantially perpendicular to the first portion.

6. The ladder assembly of claim 5, wherein the support arms each have a trim connector at a distal and thereof.
